(19) United States
(12) Patent Application Publication
(10) Pub. No.: US 2026/0172432 A1
(43) Pub. Date: Jun. 18, 2026

(54) THREAT DETECTION IN A NETWORK SECURITY SYSTEM

(71) Applicant: GOSECURE, INC., San Diego, CA (US)

(72) Inventors: Thomas Raymond WALLACE, Grosse Point Park, MI (US); Ryan ACKROYED, Saint John (CA); Jessica RADLEY, Green Cove Springs, FL (US)

(21) Appl. No.: 19/424,114

(22) Filed: Dec. 17, 2025

Related U.S. Application Data
(60) Provisional application No. 63/735,236, filed on Dec. 17, 2024.

(51) Int. Cl. H04L 9/40

(52) U.S. Cl. CPC H04L 63/1416; H04L 63/1441

(57) ABSTRACT

The system and method enhances threat detection in network security through different techniques. The system generates embedding vectors for unclassified and target domains using a pre-trained transformer model, then performs semantic similarity analysis to identify malicious domains. The system may also query a search engine with the identified malicious domain and parse the results for further threat detection. Additionally, or alternatively, the system may use a large language model, providing it with a prompt generated from domain name information to produce a domain classification, explanation, and malicious score. The system may use the domain classification, explanation, and/or malicious score for threat detection and/or security incident response.

### RELATED APPLICATIONS

This application claims priority to U.S. Provisional Application No. 63/735,236, entitled “THREAT DETECTION IN A NETWORK SECURITY SYSTEM,” filed Dec. 17, 2024, which is hereby incorporated by reference in its entirety.

### FIELD

This disclosure relates to systems and methods for protecting information systems, specifically focused on technologies for improving threat detection within network security systems.

### BACKGROUND

Domain Name System (DNS) analysis is an important component of modern cybersecurity frameworks, providing a powerful tool for threat detection and security incident response. DNS analysis involves the systematic examination of DNS traffic, queries, responses, and associated log data to identify potential security threats and investigate ongoing incidents. While DNS analysis has proven effective in detecting malicious activities, such as malware communications, data exfiltration attempts, and phishing campaigns, conventional approaches have several limitations. For example, conventional DNS analysis methods often struggle with the sheer volume and velocity of DNS data in large-scale networks, which can delay threat detection and response. Moreover, many existing systems lack the sophistication to effectively distinguish between benign anomalies and genuine threats, resulting in a high rate of false positives that can overwhelm security teams. Also, conventional DNS analysis tools frequently operate in isolation, failing to integrate seamlessly with other security systems and threat intelligence feeds, limiting their capacity to provide context-aware threat assessments.

### SUMMARY

Accordingly, there is a need for tools, systems and methods for DNS analysis for enhancing threat detection and security incident response capabilities. This application describes techniques for enhancing threat detection in network security systems using advanced natural language processing and machine learning. In some embodiments, the techniques include semantic similarity analysis using embedding vectors and large language model-based domain classification. Domain names are converted into embedding vectors using pre-trained transformer models, enabling semantic comparisons between unclassified and known malicious domains. This allows identification of conceptually similar domains, even when obfuscation techniques are used. Additionally, domain information is used to generate prompts for a large language model, which acts as a security analyst to provide classifications, explanations, and malicious scores. These methods are integrated into a comprehensive threat detection workflow that includes DNS data collection, filtering, and integration with existing security systems. The techniques improve accuracy and efficiency in threat detection by identifying sophisticated phishing attempts, detecting obfuscated malicious domains, and providing context-aware analysis. The system's ability to explain its classifications and integrate with existing infrastructure enhances overall cybersecurity posture and streamlines incident response processes.

One or more embodiments of the invention are directed to an improved method and system for managing information security risks. According to some embodiments, a method is provided for enhancing computer network security by obtaining domain name information, extracting domain names, performing semantic similarity analysis between the extracted names and known domains to identify similar domains, and performing threat detection and security incident response based on the identified similar domains.

In some embodiments, the semantic similarity analysis involves generating embedding vectors for each domain using a pre-trained transformer model, generating target vectors for known domain names, and performing similarity analysis between these vectors to identify semantically similar domains.

In some embodiments, the embedding vector generation process involves tokenizing domains to obtain input tokens, inputting these tokens into a pre-trained BERT model, and obtaining embedding vectors represented in a high-dimensional space.

In some embodiments, the pre-trained BERT model is configured to generate the vectors without further training specific to domain name analysis.

In some embodiments, a distance between vectors in the high-dimensional space is proportional to their semantic similarity.

In some embodiments, the semantic similarity analysis using the pre-trained transformer model enables semantic similarity matching that can identify conceptual similarities between domain names regardless of character-level differences.

In some embodiments, the semantic similarity analysis using the pre-trained transformer model enables semantic similarity matching that is capable of matching obfuscated domain names to their non-obfuscated counterparts, including domains using homoglyph substitution, fuzzing techniques, or randomization.

In some embodiments, generating the embedding vector for each domain in the list of domain names, and generating the target vector for each of the known domain names, is performed simultaneously.

In some embodiments, the semantic similarity analysis includes calculating a similarity score between each embedding vector and each target vector using a distance metric selected from cosine similarity, Euclidean distance, and Manhattan distance.

In some embodiments, prior to performing semantic similarity analysis, any already classified domain names are removed from the list of domain names.

In some embodiments, the domain name information is DNS traffic collected from a Security Information and Event Management (SIEM) system.

In some embodiments, the extracting further comprises extracting event information from the domain name information.

In some embodiments, the method includes querying an Internet search engine with the semantically similar domains to obtain search engine results and classifying each domain based on these results.

In some embodiments, classifying each domain comprises generating a prompt based on the search engine results and providing the prompt to a large language model to generate a domain classification.

In some embodiments, the prompt includes domain classification categories including common business domain, tracker domain, malicious domain, parked domain, suspicious domain, and content exception.

In some embodiments, querying the Internet search engine comprises formulating a search query, submitting it to the search engine, and retrieving results containing URLs and associated short descriptions.

In some embodiments, the semantic similarity analysis comprises comparing batches of DNS record embedding vectors against batches of target domain embedding vectors and identifying semantically similar domains by detecting semantic similarities to known malicious domains.

In some embodiments, the domain name information comprises DNS event data from a security information and event management system, and the method includes parsing the DNS event data, filtering to remove previously classified domains, and generating embedding vectors for unclassified domains.

In some embodiments, parsing the DNS event data comprises applying regular expression matching, processing using JSON or XML parsing, and organizing the extracted information for subsequent analysis.

In some embodiments, filtering the extracted domain information comprises maintaining a database of previously classified domains, comparing against this database, removing matching domains, and compiling remaining domains for analysis.

In some embodiments, the method includes updating the database with domain classification, explanation, and malicious score for semantically similar domains, and flagging suspicious domains for further action.

In some embodiments, the semantic similarity analysis includes comparing unclassified domains with customer domains, generating a ranked list based on semantic similarity, and selecting top-ranked domains for further analysis.

In some embodiments, the method includes generating classification records for semantically similar domains, integrating them into a security product, and configuring alerts for suspicious network traffic.

In some embodiments, the method includes analyzing URL paths to identify malware hosts or redirects, generating embedding vectors for these paths, and comparing them against known malicious patterns.

In some embodiments, identifying semantically similar domains includes detecting clusters within a predetermined time period, identifying malicious domains within clusters, and automatically classifying related domains.

In some embodiments, obtaining domain name information comprises collecting DNS queries for a predetermined interval, collating identical queries, and filtering out classified domains.

In some embodiments, the method includes establishing a baseline of common customer DNS traffic patterns, detecting deviations in real-time, and flagging unusual patterns for investigation.

In some embodiments, the semantic similarity analysis is applied to arbitrary text strings associated with network traffic or security events, generating embedding vectors for these strings, and using the classifications to enhance threat detection capabilities beyond domain name analysis.

According to some embodiments, a method is provided for enhancing threat detection in a network security system. The method includes receiving domain name information from one or more computer systems. The method also includes generating a prompt based on the domain name information. The method also includes providing the prompt to a large language model to generate a domain classification, associated explanation, and a malicious score. The method also includes performing threat detection and security incident response based on the domain classification, associated explanation, and the malicious score.

In some embodiments, the prompt includes instructions for the model to act as a security analyst, text snippets based on the domain name information, a predefined list of domain classifications, and a request to classify a malicious domain based on the provided information.

In some embodiments, generating the domain classification, associated explanation, and a malicious score includes inputting the generated prompt to the large language model to obtain a classification for a domain selected from a predefined list, an explanation justifying the selected classification, and a malicious score on a predefined scale.

In some embodiments, the prompt includes a list of domain classification categories, wherein the categories include at least: common business domain, tracker domain, malicious domain, parked domain, suspicious domain, and content exception.

In some embodiments, the method further includes detecting if the large language model refuses to classify a domain due to content moderation policies, and in response to detecting that the large language model refuses to classify a domain, flagging domains that trigger content moderation for separate handling through custom security rules.

In some embodiments, the large language model interprets diverse sources of information about a domain, identifies patterns indicative of malicious or benign behavior, applies security analysis heuristics to the interpreted information, and provides reasoned justifications for its classifications.

In some embodiments, the method further includes comparing each domain against a database of previously classified domains, identifying domains in the extracted domain information that match entries in the database of previously classified domains, removing previously classified domains from further analysis, and compiling the remaining non-matching domains into the set of unclassified domains for subsequent analysis by the large language model.

In some embodiments, the method further includes updating a domain classification database with the domain classification, explanation, and malicious score, and flagging domains classified as malicious or suspicious for further action in a security operations center of a security information and event management system.

In some embodiments, the method further includes integrating the domain classification, associated explanation, and the malicious score into a security product, configuring the security product to flag or alert for network traffic involving domains classified as malicious or suspicious, and enabling further action to be taken based on these flags or alerts.

In some embodiments, the method further includes analyzing paths within domain URLs to identify potential malware hosts or redirects, providing the URL path information to the large language model for analysis, and flagging domains with URL paths that the large language model identifies as malicious for further investigation.

In some embodiments, the method further includes identifying potentially malicious domains by detecting clusters of semantically similar domain names within a predetermined time period, identifying if any domain within a cluster is classified as malicious, and automatically classifying other domains within the same cluster as potentially malicious based on their semantic similarity.

In some embodiments, the method further includes collecting DNS queries for a predetermined time interval, collating identical domain queries within the collected DNS queries, and filtering out already classified domains before providing the domains to the large language model for analysis.

In some embodiments, the method further includes establishing a baseline of common customer DNS traffic patterns, detecting deviations from this baseline in real-time DNS traffic, and flagging unusual patterns for deeper investigation using the large language model.

In some embodiments, the method further includes implementing the method as an API service, receiving domain names from external sources through the API, performing real-time analysis of the received domain names using the large language model, and returning classification results through the API for use in threat detection and response systems.

In some embodiments, the large language model is applied to arbitrary text strings associated with network traffic or security events, the method further comprising providing the arbitrary text strings to the large language model, obtaining classifications and explanations for the arbitrary text strings from the large language model, and using the classifications to enhance threat detection capabilities beyond domain name analysis.

In some embodiments, the method further includes receiving Domain Name System (DNS) event data from a security information and event management system for a predetermined time interval, parsing the DNS event data to extract domain information and associated event identifiers, filtering the extracted domain information to remove previously classified domains to generate a set of unclassified domains, identifying potentially malicious domains from the set of unclassified domains, for each potentially malicious domain, providing parsed data to the large language model to generate a corresponding domain classification and associated explanation, generating a classification record for each potentially malicious domain comprising the domain, its classification, explanation, and a malicious score, and updating the security information and event management system with the generated classification record to enable threat detection and security incident response based on the domain classification and associated explanation.

In some embodiments, the method further includes, for each potentially malicious domain: querying a search engine with the potentially malicious domain, parsing resulting search engine data, and providing the parsed resulting search engine data to the large language model as part of the parsed data.

In some embodiments, querying the search engine includes formulating a search query using the potentially malicious domain, submitting the search query to the search engine, retrieving search results containing web pages referencing the potentially malicious domain, and extracting relevant text snippets from the retrieved search results.

In some embodiments, a computer system has one or more processors, memory, and a display. The one or more programs include instructions for performing any of the methods described herein.

In some embodiments, a non-transitory computer readable storage medium stores one or more programs configured for execution by a computer system having one or more processors, memory, and a display. The one or more programs include instructions for performing any of the methods described herein.

### BRIEF DESCRIPTION OF THE DRAWINGS

FIG. 1 is a schematic diagram of an example system for enhancing threat detection and incident response in a network security system, according to some embodiments;

FIG. 2 is a system diagram of an example threat detection and security incident response server, according to some embodiments;

FIG. 3 is a schematic diagram of an example DNS resolution system, according to some embodiments;

FIG. 4 shows an example method for enhancing threat detection and incident response in a network security system, according to some embodiments;

FIG. 5 shows an example method for enhancing threat detection and incident response in a network security system, according to some embodiments;

FIG. 6 shows a schematic diagram illustrating domain clustering in vector space, according to some embodiments;

FIG. 7 shows an example search results interface demonstrating how the system gathers threat intelligence, according to some embodiments;

FIG. 8 illustrates an example prompt structure used for large language model analysis, according to some embodiments; and

FIG. 9 shows an example threat detection dashboard displaying the analysis results, according to some embodiments.

### DETAILED DESCRIPTION OF THE PREFERRED EMBODIMENTS

The following descriptions of embodiments of the invention are exemplary, rather than limiting, and many variations and modifications are within the scope and spirit of the invention. Although numerous specific details are set forth in order to provide a thorough understanding of the present invention, it will be apparent to one of ordinary skill in the art, that embodiments of the invention may be practiced without these specific details. In other instances, well-known features have not been described in detail in order to avoid unnecessarily obscuring the present invention.

One or more embodiments of the invention are directed to an improved method and system for enhancing threat detection and incident response in a network system.

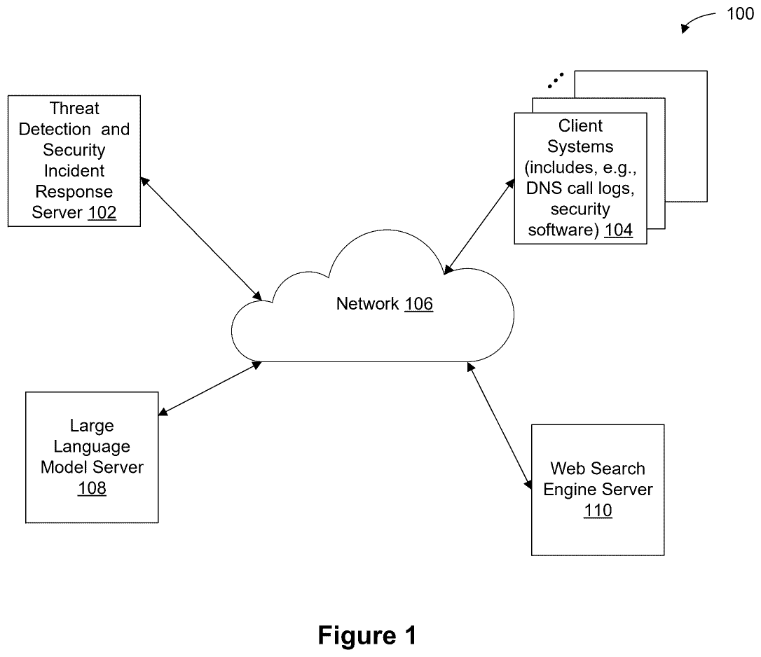

FIG. 1 is a schematic diagram of an example system 100 for enhancing threat detection and incident response in a network security system, according to some embodiments. The system includes a threat detection and security incident response server 102 coupled to one or more client systems 104, one or more web search engine servers 110, and/or one or more large language model servers 108, via a network 106 (e.g., Internet).

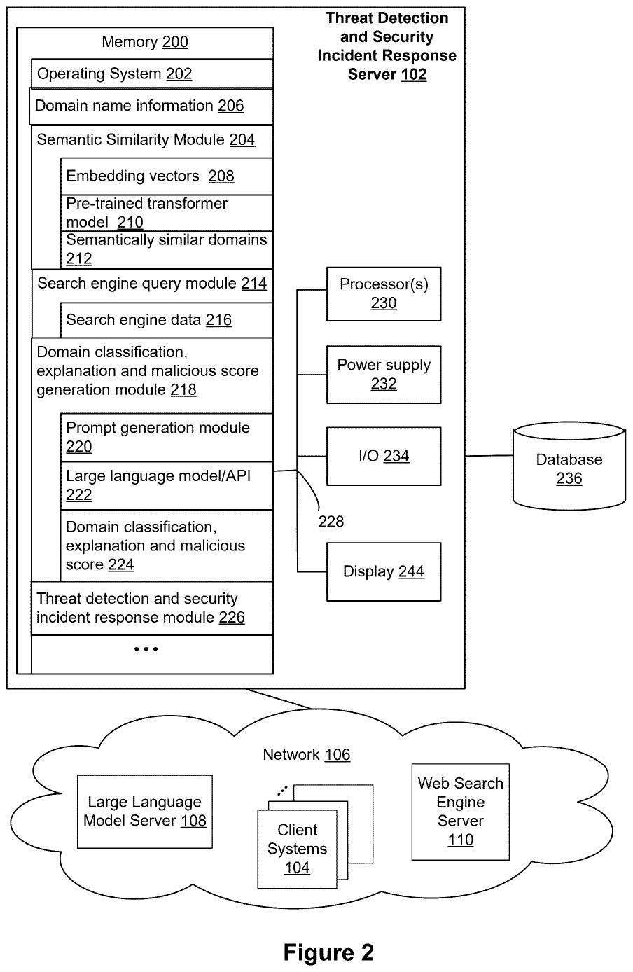

FIG. 2 is a system diagram of an example threat detection and security incident response server 102, according to some embodiments. The threat detection and security incident response server 102 typically includes one or more processor(s) 230, a memory 200, a power supply 232, an input/output (I/O) subsystem 234, and a communication bus 228 for interconnecting these components. Processor(s) 230 execute modules, programs and/or instructions stored in memory 200 and thereby perform processing operations, including the methods described herein according to some embodiments. In some embodiments, the threat detection and security incident response server 102 also includes a display 244 for displaying visualizations (e.g., threats detected, security incident responses). In some embodiments, the threat detection and security incident response server 102 generates displays or visualizations, and transmits the visualization (e.g., as a visual specification) to a client device for display. Some embodiments of the threat detection and security incident response server 102 include touch, selection, or other I/O mechanisms coupled to the threat detection and security incident response server 102 via the I/O subsystem 234, to process input from users that select (or deselect) visual elements of a displayed visualization. In some embodiments, the client device (or software therein) processes user input and transmits a signal to the threat detection and security incident response server 102 for processing. Some aspects of the threat detection and security incident response server 102 (e.g., the modules in the memory 200) are implemented in one or more client devices, according to some embodiments.

In some embodiments, the memory 200 stores one or more programs (e.g., sets of instructions), and/or data structures, collectively referred to as “modules” herein. In some implementations, the memory 200, or the non-transitory computer readable storage medium of the memory 200, stores the following programs, modules, and data structures, or a subset or superset thereof:
an operating system 202;
domain name information 204 (e.g., DNS event data) received from one or more computer systems (e.g., the client systems 104);
a semantic similarity module 206 that generates, based on the domain name information 204, embedding vectors 208 for an unclassified domain and a target domain, using a pre-trained transformer model 210, and/or performs semantic similarity analysis between the embedding vectors of the unclassified domain and the target domain to identify semantically similar domains 212;
an optional search engine query module 214 that queries a search engine with the semantically similar domains 212 to obtain search engine data 216;
an optional domain classification, explanation and malicious score generation module 218 that includes a prompt generation module 220 for generating prompts based on the domain name information 204, a large language model or API 222 for interfacing with a large language model server 108 (or alternatively use a locally stored model) and/or providing the prompt to the large language model to generate a domain classification, associated explanation, and a malicious score 224; and/or
a threat detection and security incident response module 226 to perform threat detection and/or security incident response based on the domain classification, associated explanation, and the malicious score 226, semantically similar domains 212, and/or search engine data 216.

The above identified modules (e.g., data structures, and/or programs including sets of instructions) need not be implemented as separate software programs, procedures, or modules, and thus various subsets of these modules may be combined or otherwise re-arranged in various implementations. In some embodiments, memory 202 stores a subset of the modules identified above. In some embodiments, a database 236 (e.g., a local database and/or a remote database) stores one or more modules identified above and data associated with the modules. Furthermore, the memory 200 may store additional modules not described above. In some embodiments, the modules stored in memory 200, or a non-transitory computer readable storage medium of memory 200, provide instructions for implementing respective operations in the methods described below. In some embodiments, some or all of these modules may be implemented with specialized hardware circuits that subsume part or all of the module functionality. One or more of the above identified elements may be executed by the one or more of processor(s) 230.

I/O subsystem 234 communicatively couples server the information security risk manager 102 to one or more devices such as the audits 108, the risk frameworks 110, and/or the customer systems 104, via a local and/or wide area communications network 106 (e.g., the Internet) via a wired and/or wireless connection. In some embodiments, the audits 108, the risk frameworks 110, and/or the customer systems 104 push relevant information to the information security risk manager 102. In some embodiments, the information security risk manager 102 pulls relevant information from the audits 108, the risk frameworks 110, and/or the customer systems 104.

Communication bus 228 optionally includes circuitry (sometimes called a chipset) that interconnects and controls communications between system components.

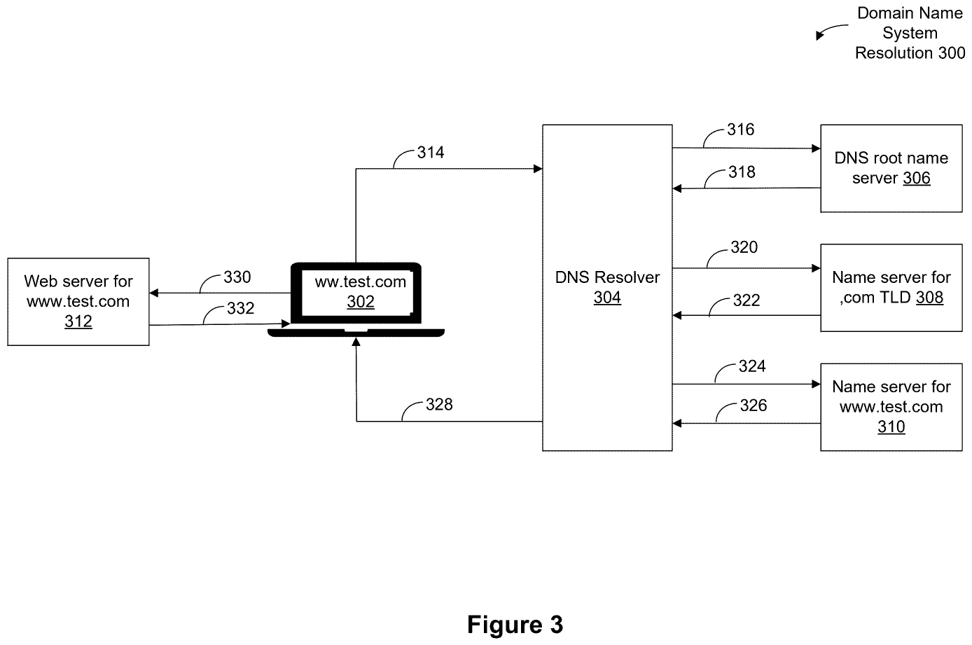

FIG. 3 is a schematic diagram of an example DNS resolution system 300, according to some embodiments. The process begins with a request for accessing www. test. com at an end user computing device 302, which is received (e.g., in step 314) by a DNS resolver 304. The resolver initiates a series of queries. A first query (e.g., in step 316) is sent to a DNS root name server 306, which responds (e.g., in step 318) directing to the . com top-level domain (TLD) name server 308. The resolver 304 then queries this TLD server (e.g., in step 320), receiving a response (e.g., in step 322) pointing to an authoritative name server 310 for www. test. com. The resolver's query to this server is shown (e.g., in step 324), with an IP address returned (e.g., in step 326). The resolver 304 then provides this IP address to the end user (e.g., in step 328). The user's browser then sends an HTTP request (e.g., in step 330) to a web server 312 at the resolved IP address. Finally, the web server 312 responds (e.g., in step 332) delivering the requested web page back to the end user. These steps illustrate the flow of information requests and responses through a DNS lookup and web page retrieval process.

### Example Method for Enhancing Threat Detection and Incident Response

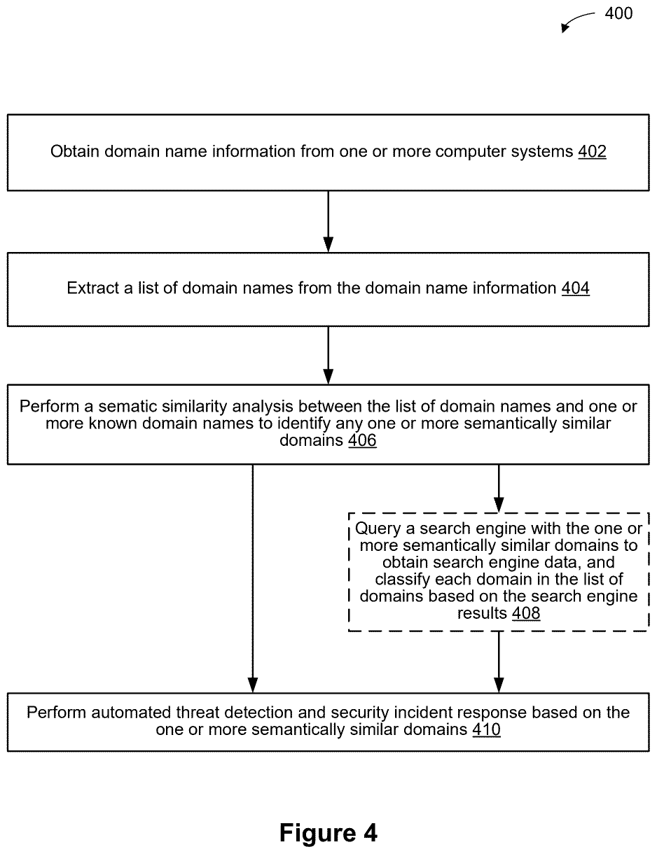

FIG. 4 shows an example method 400 for enhancing threat detection and incident response in a network security system, according to some embodiments. The method may be performed by the threat detection and security incident response server 102. The threat detection and security incident response server 102 obtains (402) domain name information 204 from one or more client systems 104.

The semantic similarity module 206 extracts (404) a list of domain names from the domain name information 204. In some embodiments, the extracting step 404 further includes extracting event information from the domain name information. In some embodiments, the semantic similarity module 206 generates embedding vectors for each domain in the list of domain names and a target vector for each of the one or more known domain names (e.g., the embedding vectors 208), using a pre-trained transformer model 210 based on the domain name information 204.

In some embodiments, the semantic similarity module 206 generates the embedding vectors 208 by tokenizing each domain in the list of domain names and each of the one or more known domain names to obtain a set of input tokens, inputting the set of input tokens into a pre-trained Bidirectional Encoder Representations from Transformers (BERT) model 210, and obtaining the embedding vectors 208 corresponding to the list of domain names and the known domain names from the BERT model 210. A pre-trained transformer model is a neural network architecture that has been trained on a large corpus of data to learn general language representations. The pre-trained transformer model can be fine-tuned for specific tasks with minimal additional training. The embedding vectors 208 represent the semantic content of the domains in a high-dimensional space. In some embodiments, the pre-trained BERT model 210 generates embedding vectors without further training specific to domain name analysis.

In some embodiments, after tokenization, the model looks up the embeddings associated with each token in an embedding matrix. An embedding matrix is a learned parameter of the model that maps each token to a dense vector representation in a continuous vector space. The embeddings of individual tokens are then combined to obtain a single embedding for the entire domain name. This aggregation can be done in various ways, such as concatenating the token embeddings, averaging the token embeddings, and using a weighted sum of the token embeddings.

In some embodiments, the resulting embedding is a dense vector that represents the domain name in a continuous vector space. The dimensionality of the embedding vector is typically much lower than the number of unique tokens in the vocabulary, allowing for efficient storage and computation. Semantically similar or related domain names will have embeddings that are close to each other in the vector space. This property enables machine learning models to capture and leverage the semantic and contextual information present in the domain names. Embeddings are used for classifying domain names into categories based on their content or purpose, identifying suspicious or malicious domain names based on their embedding representations, and/or suggesting related or similar domain names based on their embeddings. By converting domain names into embeddings, machine learning models can effectively process and understand the semantic relationships between domain names, leading to improved performance in tasks like domain classification, abuse detection, and recommendation.

In some embodiments, the system utilizes specific tools and libraries to implement these techniques efficiently. For example, Python may be used as the programming language, with libraries such as Pytorch, transformers, and tldextract. For semantic similarity matching, the system can use the BERT transformer model from HuggingFace, namely the “sentence-transformers/all-MiniLM-L6-v2” model. This pre-trained model enables the generation of embedding vectors without requiring additional training tailored to domain name analysis, thus streamlining the process while maintaining high accuracy.

The semantic similarity module 206 performs (406) a semantic similarity analysis between the list of domain names and one or more known domain names to identify any one or more semantically similar domains (e.g., the malicious domain 212). In some embodiments, this step includes performing the semantic similarity analysis using the embedding vectors of the unclassified domain and the target domain to identify a semantically similar domain 212. In some embodiments, the embedding vectors 208 represent the unclassified domain and the target domain in a high-dimensional space that captures semantic relationships between domains. In this context, a high-dimensional space refers to a mathematical space with many dimensions, typically hundreds or thousands, where each dimension represents a specific feature or attribute of the data being analyzed.

The embedding vectors 208 enable semantic similarity matching that identifies conceptual similarities between domain names regardless of character-level differences and matches obfuscated domain names to their non-obfuscated counterparts, including domains using homoglyph substitution, fuzzing techniques, and/or randomization. Homoglyph substitution involves replacing characters with visually similar ones (e.g., using “l” for “1”, using “0” for “o”). Fuzzing techniques introduce random variations in domain names. Randomization involves adding random characters or rearranging parts of the domain name. The results can match, for example, the string “g000gle” to the string “google” and the string “push123” to the string “381pu$h,” effectively bypassing homoglyph, fuzzing, and/or randomization attacks.

A homoglyph attack is a type of phishing scam that exploits the visual similarity between characters from different scripts or languages to create fake domains that closely resemble legitimate ones. The goal is to trick users into thinking they are visiting an authentic website when in fact they are on a malicious site controlled by the attacker. Fuzzing, also known as fuzz testing, is an automated software testing technique that involves providing invalid, unexpected, or random data as inputs to a computer program. Some embodiments identify coding errors and/or security vulnerabilities by monitoring the program for exceptions, such as crashes, failing assertions, or potential memory leaks. Randomization attacks are techniques used by attackers to exploit weaknesses or bypass security measures that rely on randomness or unpredictability.

In some embodiments, the semantic similarity module 206 generates the embedding vectors 208 for each domain in the list of domain names and for each of the one or more known domain names simultaneously (e.g., batches of domain name system (DNS) record domains and batches of target domains are processed simultaneously) to optimize performance. The semantic similarity module 206 performs the semantic similarity analysis by calculating a similarity score between each embedding vector corresponding to the list of domain names and each embedding vector corresponding to the known domain names (sometimes referred to as a target vector) using a distance metric, such as cosine similarity, Euclidean distance, or Manhattan distance.

A distance metric is a mathematical function that defines the distance between two points in a space, satisfying certain properties such as non-negativity and symmetry. Common distance metrics include Euclidean distance, cosine similarity, and Manhattan distance. In some embodiments, the semantic similarity module 206 performs the semantic similarity analysis by comparing batches of DNS record embedding vectors against batches of target domain embedding vectors and identifying semantically similar domains 212 by detecting semantic similarities to known malicious domains, regardless of superficial differences in character composition or structure of the domain names.

In some embodiments, prior to performing the semantic similarity analysis, any already classified domain names are removed from the list of domain names so that the list of domain names only contains unclassified domain names.

In some embodiments, the domain name information is Domain Name System (DNS) traffic collected from a Security Information and Event Management (SIEM) system.

In some embodiments, the search engine query module 214 queries (408) a search engine with the one or more semantically similar domains 212 (e.g., sometimes referred to as malicious domains) to obtain search engine data 216. The threat detection and security incident response module 226 then performs threat detection and security incident response based on parsing the search engine data 216. In some embodiments, the search engine query module 214 formulates a search query using the one or more semantically similar domains 212, submits the search query to the web search engine servers 110, retrieves search results containing a list of one or more Uniform Resource Locators (URLs) and associated short descriptions of content associated with each of the one or more URLs, where classifying each domain in the list of domains is based on at least some of the URLs and/or short descriptions.

In some embodiments, the system uses a search engine (e.g., DuckDuckGo) for gathering comprehensive information about domains. The resulting search data is then processed and used to generate prompts for OpenAI's GPT-4 model, which functions as the large language model for domain classification. The model is instructed to assume the role of a security analyst and classify domains into specific predefined categories. These categories include common business domains, tracker domains, malicious domains, parked domains, suspicious domains, and a special category for content that triggers OpenAI's content moderation policies. This approach allows for nuanced classification based on the latest available information about each domain. In some embodiments, the system uses OpenAI's GPT-4o model and integrates with security information and event management systems like FortiSIEM. The search results from search engines tend to closely match real-world uses for specific domains. For example, results for a common business domain typically include that business's name and how it uses the domain, while results for a malicious domain often include entries from malware tracker sites and forum posts describing malicious behavior.

The threat detection and security incident response module 226 performs (410) threat detection and security incident response based on the semantically similar domains 212.

In some embodiments, the domain name information includes Domain Name System (DNS) event data received from a Security Information and Event Management (SIEM) system. The semantic similarity module 206 extracts the list of domain names by parsing the DNS event data to extract the list of domain names and associated event identifiers. The semantic similarity module 206 also filters from the list of domain names to remove previously classified domains, so that the list of domain names only contains unclassified domains. The semantic similarity module 206 also generates embedding vectors 208 for the unclassified domains of the list of domain names and one or more target domains using the pre-trained transformer model 210. The semantic similarity module 206 performs the semantic similarity analysis between the embedding vectors and the at least one target domain to identify the one or more semantically similar domains 212.

Some embodiments interface with a Security Information and Event Management (SIEM) system for DNS (Domain Name System), which is a specialized application that collects, analyzes, and/or correlates DNS-related data to enhance security monitoring and threat detection. SIEM solutions aggregate and analyze security data from various sources within an organization's IT infrastructure, including servers, applications, and network devices. SIEM is useful for real-time security event analysis, enabling organizations to identify potential threats, respond to incidents, and meet compliance requirements. In SIEMs, DNS data is used for identifying malicious activities, as it can reveal patterns associated with cyber threats, such as domain generation algorithms used by malware or command-and-control communications. Effective SIEM solutions should not only ingest DNS summaries but also detailed DNS queries to provide comprehensive visibility into network activities.

For data ingestion, DNS-focused SIEM captures detailed DNS query logs, which include requests made to DNS servers. This data is used for detecting anomalies and potential threats. By correlating DNS data with other security logs, SIEM systems can identify suspicious patterns, such as unusual spikes in DNS queries or requests to known malicious domains. SIEM tools facilitate rapid incident response by providing security teams with insights into DNS-related threats, enabling them to take proactive measures to mitigate risks. Many regulatory frameworks require organizations to maintain detailed logs of their network activities, including DNS queries. SIEM solutions help ensure compliance by automating the collection and reporting of this data. Implementing DNS data ingestion in a SIEM can include configuring DNS servers to log queries properly, managing the volume of data generated, and ensuring that the SIEM is tuned to minimize false positives while maximizing threat detection capabilities. SIEM for DNS can be used to provide a robust cybersecurity strategy, enabling organizations to monitor, detect, and respond to threats effectively by leveraging detailed DNS data.

In some embodiments, the system parses the DNS event data by applying regular expression matching to the DNS event data to identify domain names, processing the DNS event data using at least one of JSON parsing and XML parsing to extract structured information, and organizing the extracted domain names and structured information into a format suitable for subsequent semantic similarity analysis.

In some embodiments, the semantic similarity module 206 performs the semantic similarity analysis by comparing the list of domain names with one or more known domain names. The list of one or more domain names includes a set of unclassified domains and the one more known domain names include a list of customer domains. The semantic similarity module 206 generates a ranked list of unclassified domains based on their semantic similarity to the customer domains. This step includes identifying those unclassified domains that are either variations of the customer domains (which may indicate brand impersonation and/or phishing attempts) or conceptually related to the customer domains, regardless of lexical similarities, and selecting a predetermined number of top-ranked domains from the ranked list, for further automated domain reputation analysis.

In some embodiments, the system filters the extracted domain information by maintaining a database 236 of previously classified domains, comparing each domain of the list of domain names against the database 236, removing from the list of domains any domains that match entries in the database 236 of previously classified domains, and compiling the remaining non-matching domains into the set of unclassified domains for subsequent semantic similarity analysis and automated domain reputation search.

A malicious score is a numerical value assigned to a domain that indicates the likelihood of it being malicious. It is typically calculated based on various factors such as similarity to known malicious domains, unusual patterns in the domain name, and associated network behaviors. In some embodiments, the system updates the database 236 of previously classified domains with a domain classification, explanation, and malicious score 224 for the one or more semantically similar domains 212 and flags domains classified as malicious or suspicious for further action in a security operations center of a security information and event management system.

In some embodiments, the system generates a classification record for each one or more semantically similar domains 212 comprising the domain, its classification, explanation, and a malicious score 224, integrates the generated classification records into a security product, configures the security product to generate an alert for network traffic involving domains classified as malicious or suspicious, and enables further action to be taken based on these alerts.

In some embodiments, the system analyzes paths within domain URLs to identify malware hosts or redirects, the semantic similarity module 206 generates embedding vectors 208 for the URL paths, the semantic similarity module 206 compares the URL path embedding vectors against embedding vectors of known malicious path patterns, and flags domains with URL paths that have high semantic similarity to known malicious patterns for further investigation.

In some embodiments, the semantic similarity module 206 identifies the one or more semantically similar domains 212 by detecting clusters of semantically similar domain names within a predetermined time period, identifying if any domain within a cluster is classified as malicious, and automatically classifying other domains within the same cluster as malicious based on their semantic similarity. In the context of large language models, semantic similarity refers to the degree of meaning-based relatedness between words, phrases, or in this case, domain names. The model can identify domains with similar purposes or intents, even if they differ in spelling or structure.

In some embodiments, the system obtains the domain name information by collecting DNS queries for a predetermined time interval, collating identical domain queries within the collected DNS queries, and filtering out already classified domains before performing the semantic similarity analysis. This process optimizes efficiency by reducing the volume of domains that need to undergo full analysis. In some embodiments, the system first collates identical domain queries to avoid redundant processing. The system then filters out domains that have been previously classified, focusing the computational resources on truly unclassified domains. For domains flagged as potentially malicious or of interest during the semantic similarity analysis, the system conducts an automated domain reputation search. This involves querying a search engine, parsing the results, and feeding this information into the large language model for classification. The resulting classifications, complete with explanations and malicious scores, are then integrated back into the security information and event management system. This integration enables threat detection and response based on predefined rules and policies, streamlining the overall security operations process.

In some embodiments, the system performs one of more of the following steps: (i) examine customer logs for all DNS queries and associated domains; (ii) collate identical domains and filter out already classified domains; (iii) for unclassified domains, perform a search engine search; (iv) retrieve HTML of search results; (v) pass these results to the large language model with instructions to classify the domain; (vi) flag domains that the model cannot classify or that trigger content moderation policies for human review; (vii) process customer domains through semantic similarity analysis to identify and classify similar domains; and (viii) update the security product's database with the final set of classified domains to enable flagging or alerts for malicious or suspicious domain calls.

In some embodiments, the system establishes a baseline of common customer DNS traffic patterns, detects deviations from this baseline in real-time DNS traffic, and flags unusual patterns for deeper investigation using the semantic similarity analysis and automated domain reputation search. To establish a baseline of common customer DNS traffic patterns, in some embodiments, the system analyzes historical DNS query logs over a significant period (e.g., 30 days). The system identifies frequently queried domains, typical query volumes, and common time-based patterns. This baseline is then used to detect anomalies in real-time traffic, such as sudden spikes in queries to unusual domains or off-hours activity that deviates from normal patterns.

In some embodiments, the system implements the method as an API service, receives domain names from external sources through the API, performs real-time analysis of the received domain names using the semantic similarity analysis and automated domain reputation search, and returns classification results through the API for use in threat detection and response systems.

In some embodiments, the semantic similarity module 206 applies the semantic similarity analysis to arbitrary text strings associated with network traffic or security events. This process includes generating embedding vectors 208 for the arbitrary text strings, comparing the embedding vectors against embedding vectors of known malicious or benign text patterns, classifying the arbitrary text strings based on their semantic similarity to known patterns, and using the classifications to enhance threat detection capabilities beyond domain name analysis. When applying semantic similarity analysis to arbitrary text strings, in some embodiments, the system tokenizes the strings and generates embedding vectors using the pre-trained transformer model. These vectors are then compared against known malicious or benign patterns. For example, the system can analyze email subject lines, HTTP request parameters, or log entry descriptions to identify potential threats based on their semantic similarity to known malicious patterns.

Some embodiments provide hacked site analysis capabilities to identify compromised legitimate domains. This can include, for example, analyzing URL paths within otherwise valid business domains to detect patterns indicative of malware or malicious redirects. For example “validsite.tld/path/to/malware.exe” is a pattern that is identified as likely malicious. These type of patterns can be input into the semantic similarity engine to identify and/or detect hacked site malware hosts and redirects. Some embodiments detect permutations of known malicious domains in ongoing campaigns, leveraging the semantic similarity techniques to identify variations of confirmed malicious domains in real-time. Some embodiments identify unusual customer behavior patterns by establishing baselines of normal DNS traffic and flagging significant deviations for further investigation.

Some embodiments provide enhanced automated investigations using sandbox environments to analyze domain behavior directly, potentially enabling zero-day threat discovery. The creation of a domain reputation API allows broader use of the system's capabilities across various security tools and services. In some embodiments, the semantic similarity techniques are applied to analyze arbitrary text strings beyond just domain names, opening up possibilities for more comprehensive threat detection across various types of data. In some embodiments, the system includes cluster analysis and filtering capabilities based on semantic similarities, enabling more sophisticated grouping and analysis of potentially related security events, thus providing deeper context for domain classification and threat detection. For instance, in some embodiments, the system groups all documents purporting to be DocuSign emails for deeper analysis. Additionally, the system can flag items whose topic is supposedly DocuSign but whose links are not semantically appropriate for that topic as likely malicious.

### Another Example Method for Enhancing Threat Detection and Incident Response

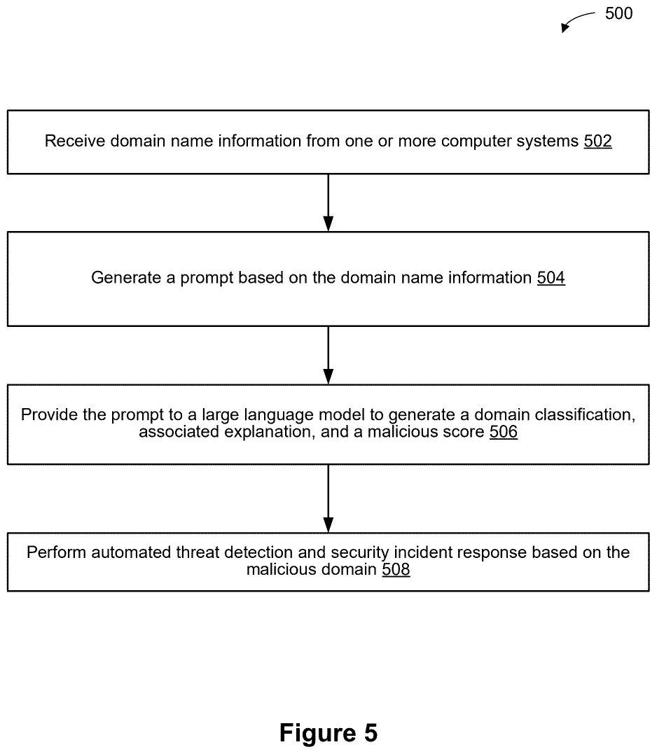

FIG. 5 shows an example method 500 for enhancing threat detection and incident response in a network security system, according to some embodiments. The method may be performed by the threat detection and security incident response server 102. The threat detection and security incident response server 102 receives (502) domain name information 204 from one or more client systems 104.

The prompt generation module 220 generates (504) a prompt based on the domain name information 204. In some embodiments, the prompt includes instructions for the large language model or API 222 to act as a security analyst, text snippets based on the domain name information 204, a predefined list of domain classifications, and a request to classify a malicious domain based on the provided information. An example of such a prompt is as follows:
system_message=“You are a security analyst looking at domains to classify them according to company policy”
prompt=“Given the following search information how would you classify the domain {domain} in terms of its use and behavior in a security context?” Please respond with a classification in json form
{{
   “domain”: “<domain_being_evaluated>”,
   “domain_class”: “<class_from_list>”,
   “explanation”: “<why_class_was_chosen>”,
   “malicious_score”: “<1_to_5_with_5_being_worst>”
}} using the following list: {DOMAIN_CLASS_LIST}
Here are the top search results for this domain: {search_results}”””

The domain classification, explanation and malicious score generation module 218 provides (506) the prompt to a large language model or API 222, which interfaces with a large language model server 108 to generate a domain classification, associated explanation, and a malicious score 224. In some embodiments, generating the domain classification, associated explanation, and a malicious score 224 includes inputting the generated prompt to the large language model or API 222 to obtain a classification for a domain selected from a predefined list, an explanation justifying the selected classification, and a malicious score on a predefined scale. A large language model is an advanced artificial intelligence system trained on vast amounts of text data, capable of understanding and generating human-like text. The large language model can perform various language tasks, such as translation, summarization, and in this context, security analysis of domain names.

In some embodiments, the prompt includes a list of domain classification categories, including at least: common business domain, tracker domain, malicious domain, parked domain, suspicious domain, and content exception. Some embodiments include detecting if the large language model or API 222 refuses to classify a domain due to content moderation policies, and in response, flagging domains that trigger content moderation for separate handling through custom security rules. Content moderation policies are guidelines and rules used by AI systems or platforms to determine what content is appropriate for analysis or display. In this context, they may prevent the model from classifying certain types of domains due to sensitive or inappropriate content. In some embodiments, when the system detects that the large language model refuses to classify a domain due to these policies, the system flags the domain for review. The review process may apply custom security rules based on the specific nature of the content in question.

In some embodiments, the large language model or API 222 interprets diverse sources of information about a domain, identifies patterns indicative of malicious or benign behavior, applies security analysis heuristics to the interpreted information, and provides reasoned justifications for its classifications. Security analysis heuristics are rule-of-thumb techniques or guidelines, for example, used to identify potential security threats. These may include checking for common malware patterns, analyzing domain registration details, or evaluating the reputation of associated IP addresses. Some embodiments include comparing each domain against a database 236 of previously classified domains, identifying domains in the extracted domain information that match entries in the database 236, removing previously classified domains from further analysis, and compiling the remaining non-matching domains into the set of unclassified domains for subsequent analysis by the large language model or API 222.

Some embodiments include collecting DNS queries for a predetermined time interval, collating identical domain queries within the collected DNS queries, and filtering out already classified domains before providing the domains to the large language model or API 222 for analysis. Some embodiments include establishing a baseline of common customer DNS traffic patterns, detecting deviations from this baseline in real-time DNS traffic, and flagging unusual patterns for deeper investigation using the large language model or API 222.

The threat detection and security incident response module 226 performs (508) threat detection and security incident response based on the domain classification, associated explanation, and the malicious score 224.

Some embodiments include updating the database 236 with the domain classification, explanation, and malicious score 224, and flagging domains classified as malicious or suspicious for further action in a security operations center of a security information and event management system. Some embodiments include integrating the domain classification, associated explanation, and the malicious score 224 into a security product, configuring the security product to flag or alert for network traffic involving domains classified as malicious or suspicious, and enabling further action to be taken based on these flags or alerts.

Some embodiments include analyzing paths within domain URLs to identify potential malware hosts or redirects, providing the URL path information to the large language model or API 222 for analysis, and flagging domains with URL paths that the large language model identifies as malicious for further investigation. Some embodiments include identifying potentially malicious domains by detecting clusters of semantically similar domain names within a predetermined time period, identifying if any domain within a cluster is classified as malicious, and automatically classifying other domains within the same cluster as potentially malicious based on their semantic similarity.

In some embodiments, the method 500 is implemented as an API service, receiving domain names from external sources through the API, performing real-time analysis of the received domain names using the large language model or API 222, and/or returning classification results through the API for use in threat detection and response systems.

In some embodiments, the large language model or API 222 is applied to arbitrary text strings associated with network traffic or security events, providing the arbitrary text strings to the large language model or API 222, obtaining classifications and explanations for the arbitrary text strings, and using the classifications to enhance threat detection capabilities beyond domain name analysis.

Some embodiments include receiving Domain Name System (DNS) event data from a security information and event management system for a predetermined time interval, parsing the DNS event data to extract domain information and associated event identifiers, filtering the extracted domain information to remove previously classified domains to generate a set of unclassified domains, identifying potentially malicious domains from the set of unclassified domains, for each potentially malicious domain, providing parsed data to the large language model or API 222 to generate a corresponding domain classification and associated explanation, generating a classification record for each potentially malicious domain comprising the domain, its classification, explanation, and a malicious score, and updating the security information and event management system with the generated classification record to enable threat detection and security incident response based on the domain classification and associated explanation.

In some embodiments, for each potentially malicious domain, the search engine query module 214 queries a search engine with the potentially malicious domain, parses resulting search engine data 216, and provides the parsed resulting search engine data 216 to the large language model or API 222 as part of the parsed data.

In some embodiments, querying the search engine includes formulating a search query using the potentially malicious domain, submitting the search query to the web search engine servers 110, retrieving search results containing web pages referencing the potentially malicious domain, and extracting relevant text snippets from the retrieved search results.

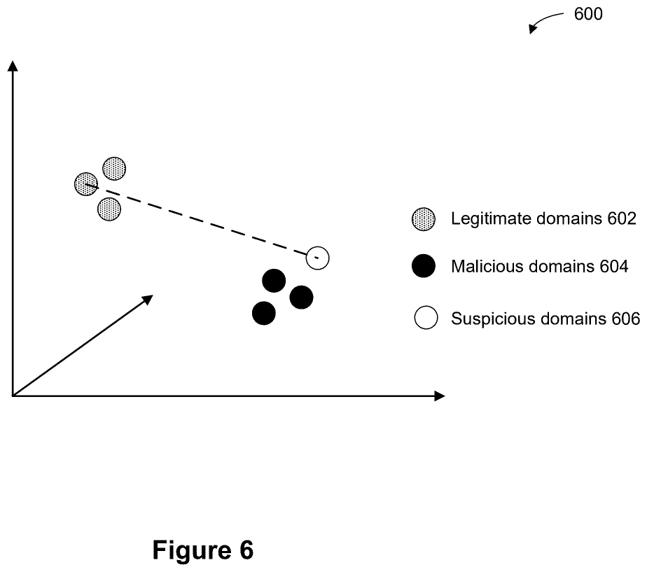

FIG. 6 shows a schematic diagram illustrating domain clustering in vector space 600, according to some embodiments. The visualization depicts three distinct clusters representing legitimate domains 602, malicious domains 604, and suspicious domains 606. This representation helps visualize how domains with similar characteristics group together in the embedding space, enabling the system to identify potentially malicious domains (sometimes referred to as suspicious domains) based on their proximity to known malicious clusters.

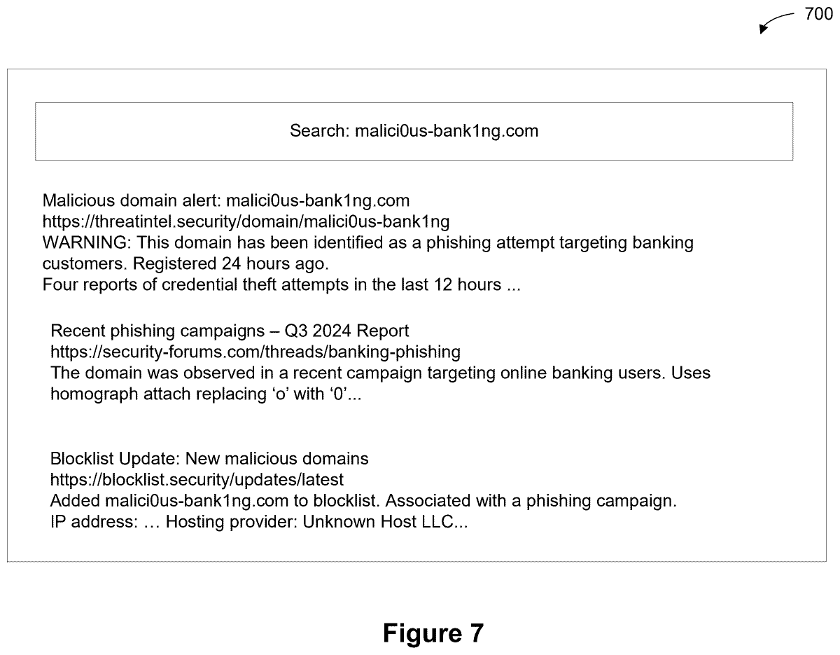

FIG. 7 shows an example search results interface 700 demonstrating how the system gathers threat intelligence, according to some embodiments. The interface displays search results for a suspicious domain “malici0us-bank1ng. com,” including threat intelligence reports, security forum discussions, and blocklist updates. Each search result provides contextual information about the domain's association with phishing attempts, its registration details, and infrastructure information that helps inform the threat analysis.

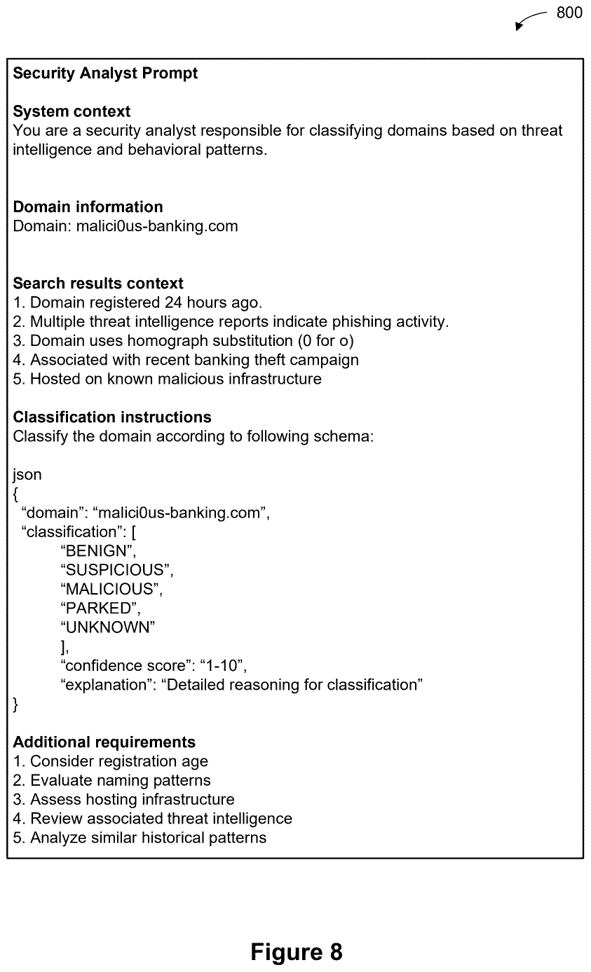

FIG. 8 illustrates an example prompt structure 800 used for large language model analysis, according to some embodiments. The prompt is structured with distinct sections including system context establishing the model's role as a security analyst, domain information specifying the target domain, search results context providing key findings, classification instructions with a defined schema, and additional analysis requirements. This structured approach ensures consistent and comprehensive domain analysis by the large language model.

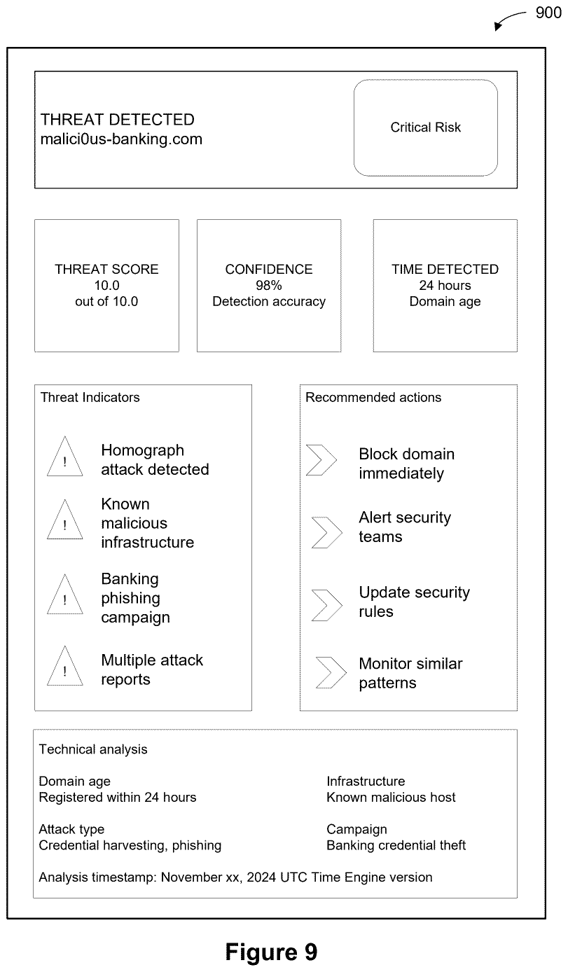

FIG. 9 shows an example threat detection dashboard 900 displaying the analysis results, according to some embodiments. The dashboard presents a comprehensive threat assessment including the overall threat score, confidence level, and time of detection. The dashboard organizes critical information into sections for threat indicators, recommended actions, and technical analysis details. The visualization uses color coding and iconography to highlight critical security information and provides actionable insights for security teams to respond to the identified threat.

While embodiments and alternatives have been disclosed and discussed, the invention herein is not limited to the particular disclosed embodiments or alternatives but encompasses the full breadth and scope of the invention including equivalents, and the invention is not limited except as set forth in and encompassed by the full breadth and scope of the claims herein.

What is claimed is:

1. A computer-implemented method for enhancing the security of a computer network, the method comprising:
obtaining domain name information from one or more computer systems;
extracting a list of domain names from the domain name information;
performing a semantic similarity analysis between the list of domain names and one or more known domain names to identify any one or more semantically similar domains;
performing threat detection and security incident response based on the one or more semantically similar domains.

2. The method of claim 1, wherein performing the semantic similarity analysis comprises:
generating, using a pre-trained transformer model, an embedding vector for each domain in the list of domain names;
generating, using the pre-trained transformer model, a target vector for each of the one or more known domain names; and
performing a semantic similarity analysis between each embedding vector and each target vector to identify any semantically similar domains.

3. The method of claim 2, wherein generating the embedding vectors comprises:
tokenizing each domain in the list of domain names and each of the one or more known domain names to obtain a set of input tokens;
inputting the set of input tokens into a pre-trained Bidirectional Encoder Representations from Transformers (BERT) model;
obtaining, from the BERT model, the embedding vectors and target vectors represented in a high-dimensional space.

4. The method of claim 3, wherein the pre-trained BERT model is configured to generate the vectors without further training specific to domain name analysis.

5. The method of claim 3, wherein a distance between vectors in the high-dimensional space is proportional to their semantic similarity.

6. The method of claim 2, wherein performing the semantic similarity analysis using the pre-trained transformer model enables semantic similarity matching that is capable of identifying conceptual similarities between domain names regardless of character-level differences.

7. The method of claim 2, wherein performing the semantic similarity analysis using the pre-trained transformer model enables semantic similarity matching that is capable of matching obfuscated domain names to their non-obfuscated counterparts, including domains using homoglyph substitution, fuzzing techniques, or randomization.

8. The method of claim 2, wherein generating the embedding vector for each domain in the list of domain names, and generating the target vector for each of the one or more known domain names, is performed simultaneously.

9. The method of claim 2, wherein performing the semantic similarity analysis comprises:
calculating a similarity score between each embedding vector and each target vector using a distance metric, wherein the distance metric is selected from a group consisting of cosine similarity, Euclidean distance, and Manhattan distance.

10. The method of claim 1, wherein prior to performing the semantic similarity analysis, any already classified domain names are removed from the list of domain names so that the list of domain names only contains unclassified domain names.

11. The method of claim 1, where the domain name information is Domain Name System (DNS) traffic collected from a Security Information and Event Management (SIEM) system.

12. The method of claim 1, wherein the extracting further comprises extracting event information from the domain name information.

13. The method of claim 1, further comprising:
querying an Internet search engine with the one or more semantically similar domains to obtain a search engine result; and
classifying each domain in the list of domains based on the search engine results.

14. The method of claim 13, wherein classifying each domain comprises:
generating a prompt based on the search engine results; and
providing the prompt to a large language model to generate a domain classification for the respective domain.

15. The method of claim 14, wherein the prompt includes a list of domain classification categories, wherein the categories include at least three of the following:
known non-malicious domain, common business domain, tracker domain, malicious domain, parked domain, suspicious domain, and content exception.

16. The method of claim 13, wherein querying the Internet search engine comprises:
formulating a search query using the one or more semantically similar domains;
submitting the search query to the Internet search engine; and
retrieving search engine results containing a list of one or more Uniform Resource Locators (URLs) and associated short descriptions of content associated with each of the one or more URLs, wherein classifying each domain in the list of domains is based on at least some of the URLs and/or short descriptions.

17. The method of claim 1, wherein performing the semantic similarity analysis comprises:
comparing batches of DNS record embedding vectors against batches of target domain embedding vectors; and
identifying the one or more semantically similar domains by detecting semantic similarities to known malicious domains, regardless of superficial differences in character composition or structure of the domain names.

18. The method of claim 1, wherein the domain name information comprises Domain Name System (DNS) event data received from a security information and event management system, and extracting the list of domain names comprises parsing the DNS event data to extract the list of domain names and associated event identifiers, the method further comprising:
filtering from the list of domain names to remove previously classified domains, so that the list of domain names only contains unclassified domains;
generating embedding vectors for unclassified domains of the list of domain names and one or more target domains using a pre-trained transformer model, wherein
performing the semantic similarity analysis is performed between the embedding vectors and at least one target domain to identify the one or more semantically similar domains.

19. The method of claim 18, wherein parsing the DNS event data comprises:
applying regular expression matching to the DNS event data to identify domain names;
processing the DNS event data using at least one of JSON parsing and XML parsing to extract structured information; and
organizing the extracted domain names and structured information into a format suitable for subsequent semantic similarity analysis.

20. The method of claim 18, wherein filtering the extracted domain information comprises:
maintaining a database of previously classified domains;
comparing each domain of the list of domain names against the database of previously classified domains;
removing from the list of domains any domains that match entries in the database of previously classified domains; and
compiling the remaining non-matching domains into the set of unclassified domains for subsequent semantic similarity analysis and automated domain reputation search.

21. The method of claim 20, further comprising:
updating the database of previously classified domains with a domain classification, explanation, and malicious score for the one or more semantically similar domains; and
flagging domains classified as malicious or suspicious for further action in a security operations center of a security information and event management system.

22. The method of claim 1, wherein performing the semantic similarity analysis comprises:
comparing the list of domain names with or more known domain names, where the list of one or more domain names comprises a set of unclassified domains and the one or more known domain names comprise a list of customer domains;
generating a ranked list of unclassified domains based on their semantic similarity to the customer domains, comprising (i) identifying those unclassified domains that are either variations of the customer domains or conceptually related to the customer domains, regardless of lexical similarities; and
selecting a predetermined number of top-ranked domains from the ranked list, for further automated domain reputation analysis.

23. The method of claim 1, further comprising:
generating a classification record for each one or more semantically similar domains, the classification record comprising the domain, its classification, explanation, and a malicious score;
integrating the generated classification records into a security product;
configuring the security product to generate an alert for network traffic involving domains classified as malicious or suspicious; and
enabling further action to be taken based on the alert.

24. The method of claim 1, further comprising:
analyzing paths within domain URLs to identify malware hosts or redirects;
generating embedding vectors for the URL paths;
comparing the URL path embedding vectors against embedding vectors of known malicious path patterns; and
flagging domains with URL paths that have high semantic similarity to known malicious patterns for further investigation.

25. The method of claim 1, wherein identifying one or more semantically similar domains comprises:
detecting clusters of semantically similar domain names within a predetermined time period;
identifying if any domain within a cluster is classified as malicious; and
automatically classifying other domains within the same cluster as malicious based on their semantic similarity.

26. The method of claim 1, wherein obtaining domain name information comprises:
collecting DNS queries for a predetermined time interval;
collating identical domain queries within the collected DNS queries; and
filtering out already classified domains before performing the semantic similarity analysis.

27. The method of claim 1, further comprising:
establishing a baseline of common customer DNS traffic patterns;
detecting deviations from this baseline in real-time DNS traffic; and
flagging unusual patterns for deeper investigation using the semantic similarity analysis and automated domain reputation search.

28. The method of claim 1, wherein the semantic similarity analysis is applied to arbitrary text strings associated with network traffic or security events, the method further comprising:
generating embedding vectors for the arbitrary text strings;
comparing the embedding vectors against embedding vectors of known malicious or benign text patterns;
classifying the arbitrary text strings based on their semantic similarity to known patterns; and
using the classifications to enhance threat detection capabilities beyond domain name analysis.

29. A computer-implemented method for enhancing threat detection in a network security system, the method comprising:
receiving domain name information from one or more computer systems;
generating a prompt based on the domain name information;
providing the prompt to a large language model to generate a domain classification, associated explanation, and a malicious score;
performing threat detection and security incident response based on the domain classification, associated explanation, and the malicious score.

30. The method of claim 29, wherein the prompt includes (i) instructions for the model to act as a security analyst, (ii) text snippets based on the domain name information, (iii) a predefined list of domain classifications, and (iv) a request to classify a malicious domain based on the provided information.

31. The method of claim 29, wherein generating the domain classification, associated explanation, and a malicious score comprises inputting the generated prompt to the large language model, to obtain (i) a classification for a domain selected from a predefined list, (ii) an explanation justifying the selected classification, and (iii) a malicious score on a predefined scale.

32. The method of claim 29, wherein the prompt includes a list of domain classification categories, wherein the categories include at least: common business domain, tracker domain, malicious domain, parked domain, suspicious domain, and content exception.

33. The method of claim 29, further comprising:
detecting if the large language model refuses to classify a domain due to content moderation policies; and
in response to detecting that the large language model refuses to classify a domain, flagging domains that trigger content moderation for separate handling through custom security rules.

34. The method of claim 29, wherein the large language model (i) interprets diverse sources of information about a domain, (ii) identifies patterns indicative of malicious or benign behavior, (iii) applies security analysis heuristics to the interpreted information, and (iv) provides reasoned justifications for its classifications.

35. The method of claim 29, further comprising:
comparing each domain against a database of previously classified domains;
identifying domains in the extracted domain information that match entries in the database of previously classified domains;
removing previously classified domains from further analysis; and
compiling the remaining non-matching domains into the set of unclassified domains for subsequent analysis by the large language model.

36. The method of claim 29, further comprising:
updating a domain classification database with the domain classification, explanation, and malicious score; and
flagging domains classified as malicious or suspicious for further action in a security operations center of a security information and event management system.

37. The method of claim 29, further comprising:
integrating the domain classification, associated explanation, and the malicious score into a security product;
configuring the security product to flag or alert for network traffic involving domains classified as malicious or suspicious; and
enabling further action to be taken based on these flags or alerts.

38. The method of claim 29, further comprising:
analyzing paths within domain URLs to identify potential malware hosts or redirects;
providing the URL path information to the large language model for analysis; and
flagging domains with URL paths that the large language model identifies as malicious for further investigation.

39. The method of claim 29, further comprising identifying potentially malicious domains by:
detecting clusters of semantically similar domain names within a predetermined time period;
identifying if any domain within a cluster is classified as malicious; and
automatically classifying other domains within the same cluster as potentially malicious based on their semantic similarity.

40. The method of claim 29, further comprising:
collecting DNS queries for a predetermined time interval;
collating identical domain queries within the collected DNS queries; and
filtering out already classified domains before providing the domains to the large language model for analysis.

41. The method of claim 29, further comprising:
establishing a baseline of common customer DNS traffic patterns;
detecting deviations from this baseline in real-time DNS traffic; and
flagging unusual patterns for deeper investigation using the large language model.

42. The method of claim 29, further comprising:
implementing the method as an API service;
receiving domain names from external sources through the API;
performing real-time analysis of the received domain names using the large language model; and
returning classification results through the API for use in threat detection and response systems.

43. The method of claim 29, wherein the large language model is applied to arbitrary text strings associated with network traffic or security events, the method further comprising:
providing the arbitrary text strings to the large language model;
obtaining classifications and explanations for the arbitrary text strings from the large language model; and
using the classifications to enhance threat detection capabilities beyond domain name analysis. The method of claim 29, further comprising:
receiving Domain Name System (DNS) event data from a security information and event management system for a predetermined time interval;
parsing the DNS event data to extract domain information and associated event identifiers;
filtering the extracted domain information to remove previously classified domains, thereby generating a set of unclassified domains;
identifying potentially malicious domains from the set of unclassified domains;
for each potentially malicious domain, providing parsed data to the large language model to generate a corresponding domain classification and associated explanation;
generating a classification record for each potentially malicious domain, the classification record comprising the domain, its classification, explanation, and a malicious score; and
updating the security information and event management system with the generated classification record to enable threat detection and security incident response based on the domain classification and associated explanation.

45. The method of claim 44, further comprising:
for each potentially malicious domain: (i) querying a search engine with the potentially malicious domain, (ii) parsing resulting search engine data, and (iii) providing the parsed resulting search engine data to the large language model as part of the parsed data.

46. The method of claim 45, wherein querying the search engine comprises:
formulating a search query using the potentially malicious domain;
submitting the search query to the search engine;
retrieving search results containing web pages referencing the potentially malicious domain; and
extracting relevant text snippets from the retrieved search results.
